(19) United States
(12) Patent Application Publication
(10) Pub. No.: US 2005/0030761 A1
(43) Pub. Date: Feb. 10, 2005

(54) Package LED's and electronics as a replaceable light bulb

(76) Inventor: Edward Sean Burgess, Grosse IIe, MI (US)

Correspondence Address: EDWARD S. BURGESS, 21119 KNUDSEN, GROSSE ILE, MI, 48138, US

(21) Appl. No.: 10/654,459

(22) Filed: Sep. 4, 2003

Related U.S. Application Data
(60) Provisional application No. 60/444,358, filed on Feb. 3, 2003.

(51) Int. Cl. F21V 7/04

(52) U.S. Cl. 362/555

(57) ABSTRACT

Package enough LED's and electronics into a package that will fit in the same package space as an existing replaceable light bulb.

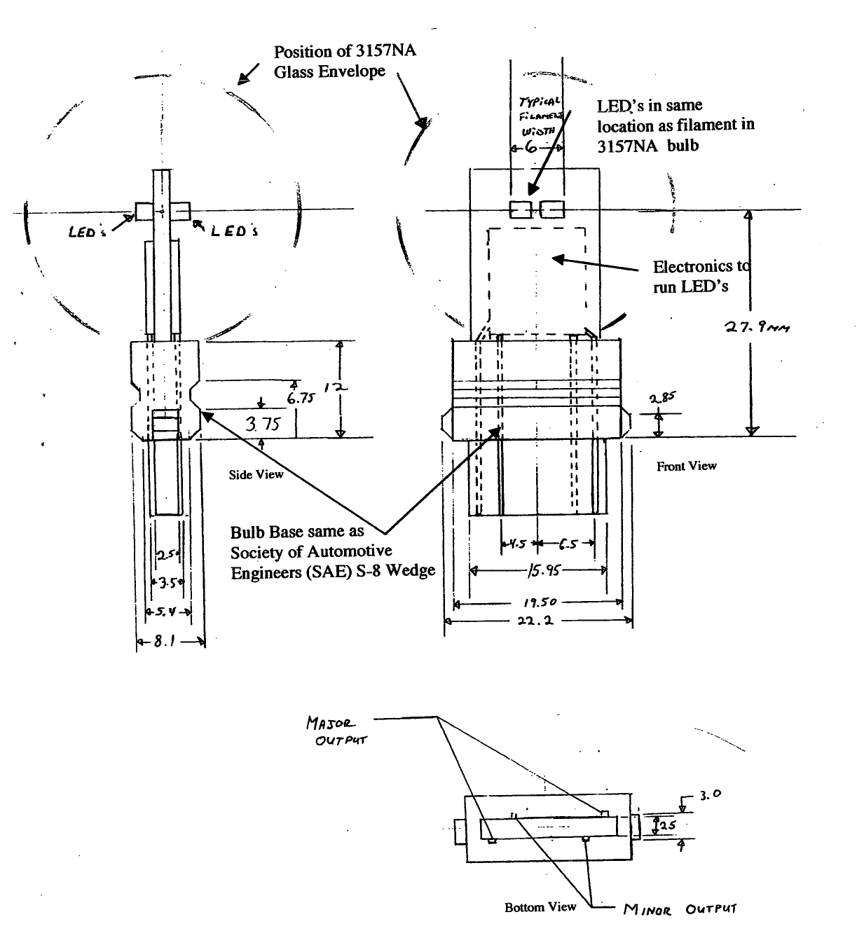

### CROSS-REFERENCE TO RELATED APPLICATIONS

Provisional Patent No. 6044358

### BACKGROUND OF THE INVENTION

Light Emitting Diodes (LED's) are a product of the modern electronic age. If treated properly in regards to the electrical inputs, LED's can produce light for a very long time (+10,000 hrs). Its efficiency on the transfer of electricity to usable light endeared the LED to the battery powered electronic. Until recently the light output per LED was very limited. LED's are currently best suited for single color applications but with the latest inventions by the LED manufactures, white output LED's are becoming commercially viable. One drawback to LED's is that they have to be driven electronically to get the light out. With ever increasing improvements in electronics, the circuits that are required to run the LED's are constantly being made smaller. The light bulb has been around for 100 years. There are countless varieties of light bulbs that fit into a gamete of fixtures. This idea is to use LED's with electronics as a replacement that fits into a fixture as a replaceable bulb.

LED's use a totally different method to make light than the traditional filament incandescent bulb. An incandescent bulb is basically a black box emitter and gets about 200 hours of useful life. An LED works by setting up two energy states for an electron to jump. When the electron makes the jump a photon is released. The size of the jump and number of electrons making the jump sets the photon wavelength (color) and intensity. There are many things that contribute/shorten the life of a filament bulb such as duty cycle, temperature it operates in, vibration, and electrical loads on the circuit. LED's have similar but different environmental concerns on their life. Some things that make the filament break have no effect on the LED and things the filament bulb can take like high heat are detrimental to the LED. Since the LED is completely different than the filament, a different set of requirements/environments apply. There are many areas where the LED features for durability equal or surpass the usefulness of a bulb. Treated right the LED can last 10,000 hours.

Typical incandescent filament light bulbs have an efficiency of 30 lumens per watt. Fluorescent, sodium and mercury vapor lamps are in the range of 50 lumens per watt. LED's typically produce 80 lumens per watt. This also equates into a cooler operation for the same lumen output. Some of the first uses of LED's (1970's) were in battery powered electronic devices, watches, calculators, toys, etc . . . where the LED is actually seen. The LED provided light output with very little energy input. One of their biggest draw back was the quantity of light that they could produce per LED device, 0.1 lumens per LED of monochromatic light. This was miniscule compared to a small bulb. A small bulb like the ones used as night-light puts out 3 candela (18 Lumens of white light). This shortage of light left LED usage primarily for direct lighting application, where you actually see the LED. Ten years ago to actually illuminate anything with LED's required very large arrays of LED's. In the automotive industry they would use 20 or more LED's for the Center High Mounted Stop Lamp, which can be done with just one bulb. In the automotive market the quantity of light per available LED device has been going up 30% per year for red and amber LED's. Also white LED's are being promoted in the trade magazines as being available. In the last few years the output of LED's has significantly advanced where 5 lumen devices are commercially available. Now, a smaller array of LED's can product the same luminance output as a bulb. Higher transmission of electricity to light, less energy is required.

A second lighting benefit of LED's is the directional nature of the light. One inefficiency of incandescent bulb is it throws light in every direction. LED can be designed to shine light in the most beneficial direction for the application. Less overall light is required but an equal amount of usable light. An example of this would be a light bulb in a socket with a reflector. An incandescent bulb basically shines light in all directions, the reflectors is used to direct most of the light in one direction. With LED's all of the light can be emitted in the direction that needs it, eliminating light losses due to reflectance and surface scatter. Less light is wasted, less light needs to be generated, and less energy is required.

LED's were originally and still are well suited for small battery (AA, C, etc . . . ) applications. LED's need a small direct current voltage applied across it (1.5V dc typical) in order to emit light. The output of the device is set in the manufacturing of the LED device. The light produced from any LED device is specific to that devices forward voltage (Vf) and drive current. It does have light output variation between its accepted minimum and maximum forward voltage. Going below the minimum produces no light. Going over the maximum will cause the LED to fail.

For any replaceable bulb/light source there is an acceptable range of electrical input. For instance, most US household light fixtures that work off of 110 Volts AC, cars work at 12.8 VDC. Knowing the application an electronic circuit can be made to turn the input, 110 VAC, into the desired LED Vf.

Improvements in output per LED, and the growth (shrinking) of electronics, a very small, very bright, very energy efficient package can be made.

### BRIEF SUMMARY OF THE INVENTION

Package enough LED's and electronics into a package that will fit in the same package space as an existing replaceable light bulb.

### BRIEF DESCRIPTION OF THE DRAWINGS

The attached drawing shows but one possible use for this invention. The drawing shows the glass portion of the SAE 3157 S8 bulb being replaced with an electronic board with LED's. The LED's are placed in close proximity of where the filament had been.

### DETAILED DESCRIPTION OF THE INVENTION

Light bulbs come in many different shapes and sizes. The light they give off is generated by the heat of a filament, the arc of electricity in sodium vapor lamps, or the byproduct of an electrical flow through a florescent tube. They do have in common the fact that the bulb can be screwed or snapped in place. If the bulb fails there is no need to rewire the fixture, just twist the old one out and screw in a new one. This idea is to use Light Emitting Diodes as the source of the light, include enough electronics to run the LED's, and mount all of this so they can be used in a fixture like an existing light bulb.

The following drawing is just one of many possible examples of packaging enough LED's into a similar package as on an existing light bulb. This particular example is an LED replacement for a Society of Automotive Engineers S-8 Wedge base 3157NA. The 3157NA is an amber light bulb with two filaments. In a typical automotive exterior lighting applications the 3157 NA bulb filaments are positioned within a lamp that will provide a lit function for the vehicle such as parking lamp, turn indicator, side marker, or a combination of any or all of these functions. The requirements are usually met with both direct light and light that is reflected off of a reflective surface. In a typical 3157 NA application the minor filament is used for a park lamp function and major filament as the turn function. There is enough change in light output between the minor and major filament that the oncoming drives know what the driver is doing.

In the following drawing the LED's are positioned in close proximity of where both the low and high filaments of a 3157NA bulb would be located. In the 3157NA application there are four wires that come into the bulb; two are ground; one is for high filament function; one for low filament function. High and low filament input is both +12 VDC. In this particular case, the LED devices input at the base would be exactly the same as a 3157NA so this device would fit into existing sockets. The electric circuit on the device would run the LED's based on the input. The low filament input would run the LED's at a lower Vf and current. When the high filament input is turn, the Vf and drive current to the LED would be increased to provide a significant change to the illumination.

In the above example the concept is to use the LED bulb as replacement for an existing bulb. It may or may not be an exact replacement in the way of light color, intensity, or electrical profile. The idea is to make an LED bulb fit the existing hardware. This is not to say that if this idea takes off that someone will not want to make a specific combination of bulb and fixture that is currently not in existence. The design of the fixture would be theirs, the design of the bulb would be related back to this idea.

Most LED's operate at one dominant wavelength. The first usage of this patent would be places where color light is required such as stoplights, automotive and truck lighting. With the advent of white LED's it may be possible someday to make an LED replacement for the standard 100, 75, and 65 watt bulbs currently in used in most homes in the USA. Or make an LED tube to replace the florescent tube used in most offices. The energy savings could be 60% for each filament bulb switched over.

1) Use Light Emitting Diodes (LED's) with applicable electronics to drive the LED's in replaceable light bulb applications.

2) Package LED(s) and electronics so they can be used in existing light fixtures

3) Package LED(s) and electronics so they can be used to develop new lighting fixtures

4) Package LED(s) and electronics so that they can replace existing replaceable light sources.

5) Package LED(s) and electronics so that they can be used as a replaceable light sources.
